(19) United States
(12) Patent Application Publication
(10) Pub. No.: US 2013/0135354 A1
(43) Pub. Date: May 30, 2013

(54) ELECTRONIC APPARATUS AND DISPLAY CONTROL METHOD

(71) Applicant: Yasuhiro OOKAWARA, Kunitachi-shi (JP)

(72) Inventor: Yasuhiro OOKAWARA, Kunitachi-shi (JP)

(73) Assignee: KABUSHIKI KAISHA TOSHIBA, Tokyo (JP)

(21) Appl. No.: 13/587,780

(22) Filed: Aug. 16, 2012

(30) Foreign Application Priority Data
Nov. 30, 2011 (JP) 2011-262862

(51) Int. Cl. G09G 5/10

(52) U.S. Cl. 345/660; 345/690

(57) ABSTRACT

According to one embodiment, an electronic apparatus includes a display, a backlight, a backlight adjusting module, and a gradation level converter. The backlight is configured to turn on with a first brightness or a second brightness which has a lower brightness level than the first brightness. The backlight adjusting module is configured to adjust a brightness of the backlight to the second brightness in response to changing of a size of a display area for displaying content on the display to a specified size or more when the backlight is turned on with the first brightness. The gradation level converter configured to execute gradation level conversion to increase a gradation level value of the content.

### CROSS-REFERENCE TO RELATED APPLICATIONS

This application is based upon and claims the benefit of priority from prior Japanese Patent Application No. 2011-262862, filed Nov. 30, 2011, the entire contents of which are incorporated herein by reference.

### FIELD

Embodiments described herein relate generally to an electronic apparatus including a backlight-equipped display, and to a display control method of controlling display on the electronic apparatus.

### BACKGROUND

In electronic apparatuses such as a personal computer, a smartphone and a mobile phone, there has been a demand for a power-saving function for reducing power consumption. For example, in a personal computer including a backlight-equipped display, the power consumption by the backlight is large. Thus, when a power-saving mode is set by the user, the brightness of the backlight of the display is lowered, thereby reducing power consumption.

In the prior art, power-saving is realized by lowering the brightness of the backlight. However, when the brightness of the backlight is lowered, the surface brightness of the display lowers and, in some cases, the content of information displayed on the display becomes difficult to view.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view illustrating the external appearance of the structure of an electronic apparatus according to an embodiment.

FIG. 2 is an exemplary block diagram illustrating the system configuration of a personal computer in the embodiment.

FIG. 3 is an exemplary block diagram illustrating the relationship between various modules for reducing power consumption by lowering the brightness of a backlight in the embodiment.

FIG. 4 is an exemplary view illustrating the outline of a technique for reducing power consumption by lowering the brightness of the backlight in the embodiment.

FIG. 5 is an exemplary graph illustrating the relationship between a surface brightness of a display (LCD) and a gradation level value of an image in the embodiment.

FIG. 6 is an exemplary flow chart illustrating an operation in the embodiment.

FIG. 7 is an exemplary view illustrating an example of a display screen of the LCD in the embodiment.

FIG. 8 is an exemplary view illustrating an example of the display screen of the LCD in the embodiment.

FIG. 9 is an exemplary view illustrating an example of the display screen of the LCD in the embodiment.

FIG. 10 is an exemplary graph illustrating gradation level conversion in the embodiment.

FIG. 11 is an exemplary view illustrating an example of the display screen of the LCD in the embodiment.

### DETAILED DESCRIPTION

Various embodiments will be described hereinafter with reference to the accompanying drawings.

In general, according to one embodiment, an electronic apparatus comprises a display, a backlight, a backlight adjusting module, and a gradation level converter. The backlight is configured to turn on with a first brightness or a second brightness which has a lower brightness level than the first brightness. The backlight adjusting module is configured to adjust a brightness of the backlight to the second brightness in response to changing of a size of a display area for displaying content on the display to a specified size or more when the backlight is turned on with the first brightness. The gradation level converter configured to execute gradation level conversion to increase a gradation level value of the content in response to lowering of a brightness of the backlight to the second brightness.

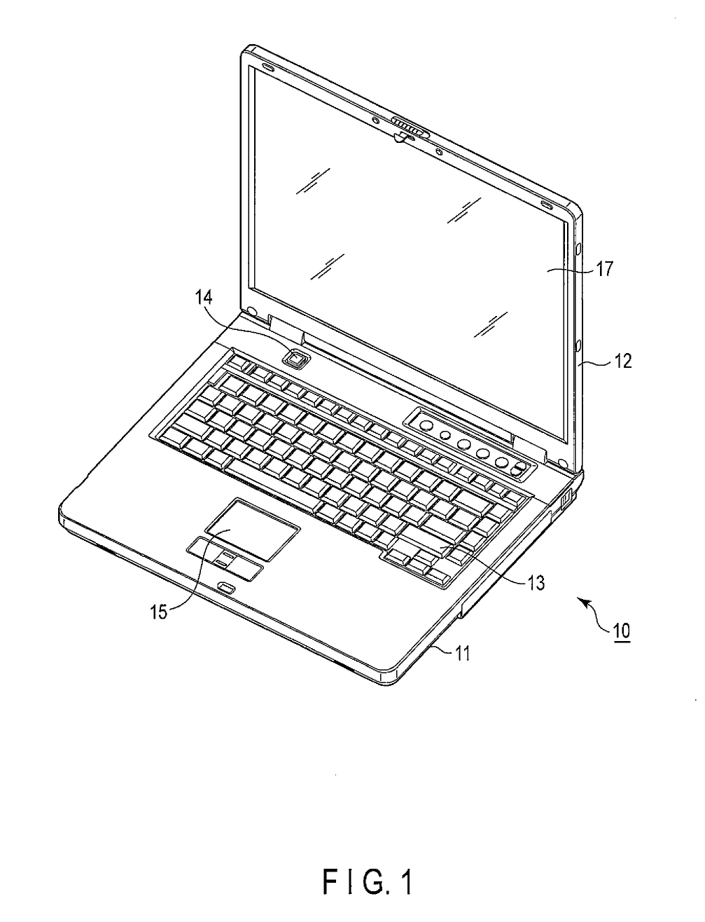

FIG. 1 is an exemplary view illustrating the external appearance of the structure of an electronic apparatus according to an embodiment. The electronic apparatus is realized, for example, as a notebook-type portable personal computer 10 which can be driven by a battery. The personal computer 10 of this embodiment includes a backlight-equipped display, and is provided with a function of reducing power consumption by lowering the brightness of the backlight, when a power-saving mode is set.

FIG. 1 is a perspective view of the personal computer 10 in the state in which a display unit 12 of the personal computer 10 is opened. The personal computer 10 is composed of a computer main body 11 and the display unit 12. A display device, which is composed of an LCD (Liquid Crystal Display) 17, is built in the display unit 12. The display screen of the LCD 17 is disposed at an approximately central part of the display unit 12.

The display unit 12 is attached to the computer main body 11 such that the display unit 12 is rotatable between an open position and a closed position. The computer main body 11 has a thin box-shaped housing in which a battery can be detachably mounted.

A keyboard 13, a power button switch 14 for powering on/off, and a touch pad 15 are disposed on the top surface of the computer main body 11.

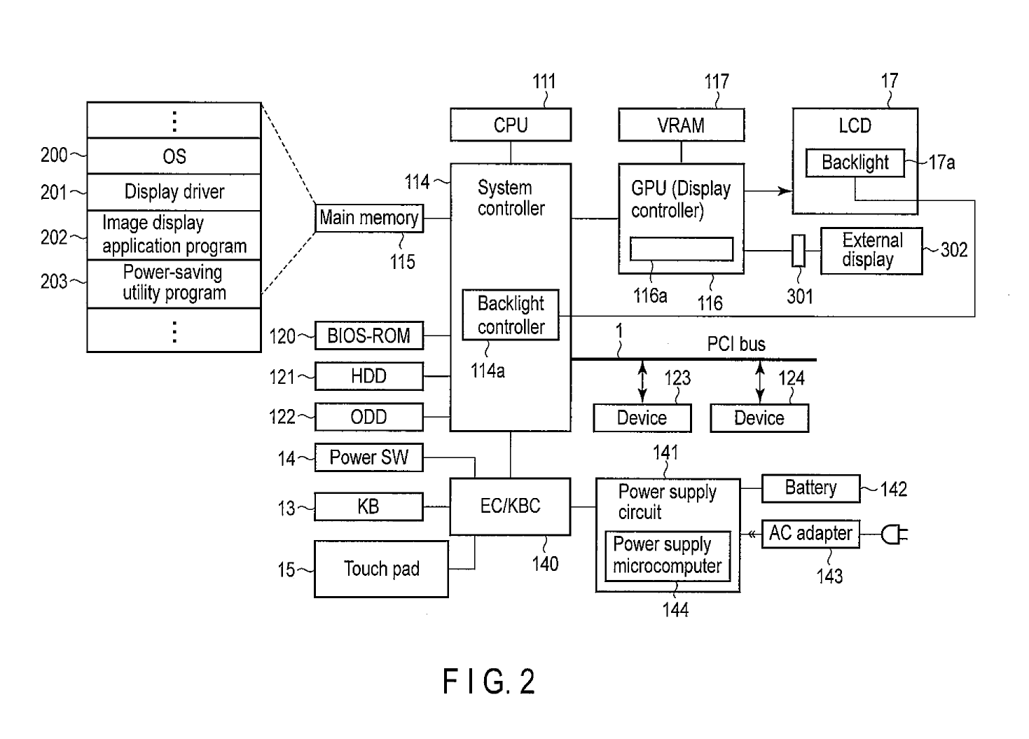

Next, referring to FIG. 2, the system configuration of the personal computer 10 according to the embodiment is described.

The personal computer 10, as shown in FIG. 2, includes a CPU 111, a system controller 114, a main memory 115, a graphics processing unit (GPU) 116, a BIOS-ROM 120, a hard disk drive (HDD) 121, an optical disc drive (ODD) 122, devices 123 and 124, an embedded controller/keyboard controller IC (EC/KBC) 140, and a power supply circuit 141.

The CPU 111 is a processor which is provided for controlling the operation of the personal computer 10. The CPU 111 executes various programs which are loaded from the HDD 121 into the main memory 115. The programs that are executed by the CPU 111 include an operating system (OS) 200, a display driver 201, an image display application program 202, and a power-saving utility program 203. The display driver 201 is a program for controlling a display circuit including the GPU 116. The image display application program 202 is a program for displaying content such as a moving picture and a still image. The power-saving utility program 203 is a program for executing control to reduce power consumption of the personal computer 10.

Besides, the CPU 111 executes a system BIOS (Basic Input/Output System) that is stored in the BIOS-ROM 120. The system BIOS is a program for hardware control.

The system controller 114 is a bridge device which connects the CPU 111 and various modules. The system controller 114 includes a memory controller which access-controls the main memory 115, a backlight controller 114a which controls the brightness of a backlight 17a provided in the LCD 17, and a controller for controlling the HDD 121 and optical disc drive (ODD) 122.

In addition, the system controller 114 communicates with the devices 123 and 124 via a PCI bus 1. The device 123 is, for example, a communication device which transmits/receives data via a network. The communication device connects to the network by radio, such as a wireless LAN (Local Area Network).

The GPU 116 is a display controller which controls the LCD 17 that is used as a display monitor of the personal computer 10, and an external display 302. The external display 302 is connected, where necessary, to an external video output terminal 301 which is provided on the computer main body 11.

Based on a display request which is sent from the CPU 111 via the system controller 114, the GPU 116 records in a video memory (VRAM) 117 image data for displaying an image on the LCD 17, and causes the LCD 17 to display an image based on the image data recorded in the VRAM 117.

The GPU 116 in this embodiment includes a gradation level conversion module 116a which converts the gradation level of an image which is displayed on the LCD 17. For example, when the brightness of the backlight 17a has been lowered in order to reduce the power consumption, the gradation level conversion module 116a converts the gradation level of the image in order to compensate a decrease in surface brightness of the LCD 17 due to the lowering of the brightness of the backlight 17a.

The embedded controller/keyboard controller IC (EC/KBC) 140 is a one-chip microcomputer in which an embedded controller for power management and a keyboard controller for controlling the keyboard (KB) 13 and touch pad 15 are integrated. The EC/KBC 140 has a function of powering on/off the personal computer 10 in accordance with the user's operation of the power button switch 14. The power on/off control of the personal computer 10 is executed by cooperation between the EC/KBC 140 and power supply circuit 141. The power supply circuit 141 generates operation power to the respective components, by using power from a battery 142 that is mounted in the computer main body 11, or power from an AC adapter 143 that is connected to the computer main body 11 as an external power supply. The power supply circuit 141 is provided with a power supply microcomputer 144, and the power consumption in each component can be measured.

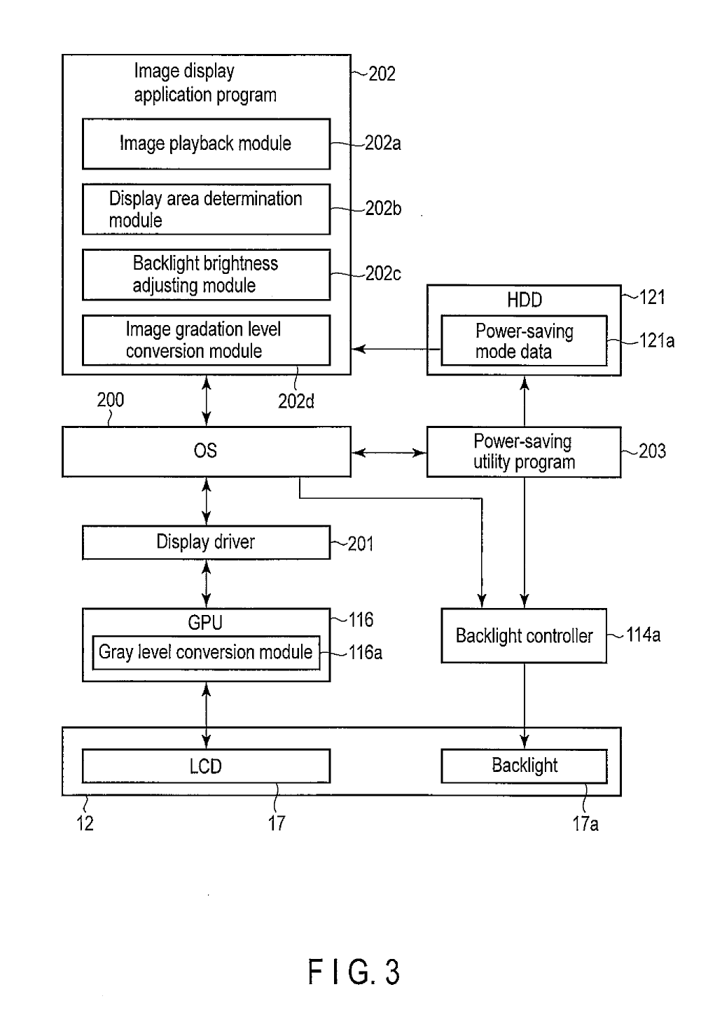

FIG. 3 is an exemplary block diagram illustrating the relationship between various modules for reducing power consumption by lowering the brightness of the backlight 17a in the embodiment.

In the present embodiment, when image content (data including a large amount of data of intermediate gradation levels, such as a moving picture or a still image) is to be displayed on the LCD 17 by the image display application program 202, the brightness of the backlight 17a is lowered to reduce power consumption, and the gradation level of the image (content) is converted in a manner to correct a decrease in brightness of the backlight 17a. The condition for lowering the brightness of the backlight 17a is that the display area for displaying image content in the screen of the LCD 17 is a predetermined size (hereinafter referred to as “specified size”) or more. The display size of the specified size or more is, for example, a size of a full-screen mode (full-screen) or such a size that the most part of the display area for displaying the process content of some other application is hidden. In addition, it is assumed that the specified size is determined in advance in the image display application program 202.

The image display application program 202 includes an image playback module 202a which plays back image content (moving picture, still image) and displays the image content on the LCD 17; a display area determination module 202b which determines whether the size of the display area for displaying the image content is a specified size or more; a backlight brightness adjusting module 202c which adjusts the brightness of the backlight 17a in accordance with the determination result of the display area determination module 202b; and an image gradation level conversion module 202d which controls the GPU 116 (gradation level conversion module 116a) in a manner to convert the gradation level of the image content so as to correct the decrease in brightness, in the case where the brightness of the backlight 17a has been lowered by the backlight brightness adjusting module 202c.

In the present embodiment, although the gradation level of the image (content) is converted by the gradation level conversion module 116a of the GPU 116 in order to correct the decrease in brightness of the backlight 17a, the image gradation level of the image content may be converted by the image gradation level conversion module 202d.

A display request for display of image content from the image display application program 202 is sent to the display driver 201 via the OS 200. The display driver 201 sends the display request to the GPU 116. The GPU 116 executes a display process in accordance with the display request from the display driver 201, stores image data in the video memory (VRAM) 117, and causes the LCD 17 to display an image corresponding to the image data. In addition, in a normal operation mode, the backlight controller 114a causes the backlight 17a to emit light with a brightness for a normal operation time.

In accordance with a user operation, the power-saving utility program 203 sets a power-saving mode for causing the personal computer 10 to operate in the state in which the power consumption of the personal computer 10 is lowered. If a transition to the power-saving mode has been instructed, the power-saving utility program 203 records power-saving mode data 121a in, e.g. the HDD 121.

If the power-saving mode has been set, the image display application program 202 executes control, by the display area determination module 202b and backlight brightness adjusting module 202c, to reduce the power consumption by lowering the brightness of the backlight 17a, and to prevent the image content, which is displayed on the LCD 17, from becoming difficult to view. Specifically, in the power-saving mode described in this embodiment, when the image display application program 202 operates, if the display area for displaying image content is the specified size (e.g. full-screen display) or more, the brightness of the backlight 17a is lowered, thereby reducing the power consumption. In addition, when the brightness of the backlight 17a has been lowered, the gradation level value of the image content is raised in accordance with the decrease in brightness of the backlight 17a, thereby preventing the image content from appearing dark.

Next, the operation in the present embodiment is described.

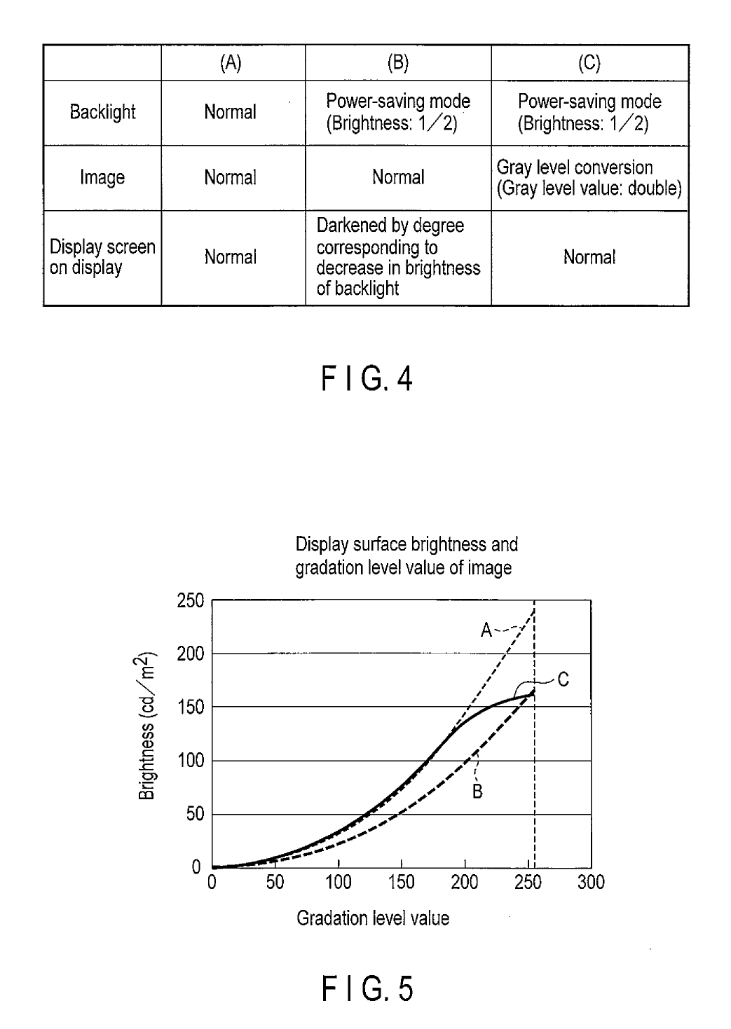

To begin with, referring to FIG. 4, a description is given of the outline of the technique for reducing power consumption by decreasing the brightness of the backlight 17a by the personal computer 10 of the present embodiment.

The surface brightness of the LCD 17 is determined by the brightness of the backlight 17a and the gradation level value of image content. As indicated by (A) in FIG. 4, at the time of the normal operation, the backlight 17a is turned on with a brightness for the normal operation time, and the image content is displayed without being subjected to a gradation level conversion process. In this case, the image content is displayed on the LCD 17 with a normal brightness level.

When the power-saving mode has been set, the personal computer 10 reduces the power consumption by lowering the brightness of the backlight 17a. As indicated by (B) in FIG. 4, when the brightness of the backlight 17a has been lowered in the power-saving mode (e.g. brightness: ½), if the image content is similarly displayed as in the case of the normal operation time, without being subjected to the gradation level conversion process, the surface brightness of the LCD 17 lowers by the degree corresponding to the decrease in brightness of the backlight 17a. In short, the image content displayed on the LCD 17 appears dark.

Taking the above into account, in the personal computer 10 of the present embodiment, as indicated by (C) in FIG. 4, the image content is subjected to the gradation level conversion process in a manner to correct the decrease in brightness of the backlight 17a. For example, when the brightness of the backlight 17a has been decreased to ½, the gradation level value of the image content is doubled by the gradation level conversion process. As a result, the surface brightness of the LCD 17 can be raised to the same level as in the case of the normal operation time.

Thus, by controlling the brightness of the backlight 17a and the gradation level value of the image content, it becomes possible to display the image content with a brightness close to the original apparent brightness, while reducing the power consumption.

FIG. 5 is a graph illustrating the relationship between the surface brightness of the display (LCD 17) and the gradation level value of an image in the embodiment.

In FIG. 5, a broken line A indicates the surface brightness of the display, which corresponds to the gradation level value of the image at a time when the backlight 17a is turned on with a brightness for the normal operation time. A broken line B indicates the surface brightness of the display, which corresponds to the gradation level value of the image at a time when the brightness of the backlight 17a has been lowered for the power-saving mode. A solid line C indicates the surface brightness of the display, which corresponds to the gradation level value of the image which has been subjected to the gradation level conversion process in a manner to correct the decrease in brightness of the backlight 17a. In the meantime, a gradation level value 255 corresponds to white that is displayed on the display.

As indicated by the solid line C in FIG. 5, even if the brightness of the backlight 17a is lowered, the surface brightness of the display can be set to be equal to the surface brightness at a time prior to the decrease of the brightness of the backlight 17a, by subjecting the image to the gradation level conversion process. However, it is up to the intermediate gradation level (e.g. gradation level value 200) that the surface brightness of the display can be corrected to be equal to the surface brightness at a time prior to the decrease of the brightness of the backlight 17a

At high gradation levels (e.g. gradation level value 200 or more), the display surface brightness is increased to a sufficiently high value by the brightness of the backlight 17a. Thus, even if the gradation level value of the image is corrected by the degree corresponding to the decrease of the brightness of the backlight 17a, the brightness is clipped. Specifically, when an image with a high gradation level is displayed, even if the gradation level conversion process is executed in order to raise the gradation level value of the image, the brightness does not increase in accordance with the raising of the gradation level, and the image appears dark.

Thus, the method of converting the gradation level value of an image in a manner to correct the decrease in brightness of the backlight 17a is effective at a time of displaying image content (moving picture, still image) with a large amount of data at intermediate gradation levels, such as a video image or a photo. However, this method is less effective at a time of displaying a screen including characters or lines in black on a white background, such as a screen which is displayed by a word-processing application (word processor) or a spread sheet application.

For example, when a display area for displaying image content and a display area for displaying a process screen by a word-processing application are mixedly present on the LCD 17, even if the gradation level value conversion is executed to correct the decrease in brightness of the backlight 17a, the display area of the process screen by the word-processing application becomes dark.

In the personal computer 10 of this embodiment, when the size of the display area for displaying image content by the image display application program 202 is the specified size or more (e.g. full-screen mode), the brightness of the backlight 17a is lowered and the gradation level value of the image content is converted, thereby preventing the image content from appearing dark. In addition, in the personal computer 10, when the size of the display area for displaying image content is not the specified size or more, the brightness of the backlight 17a is restored to the original brightness level and the gradation level conversion process for the image content is not executed.

For example, when the size of the display area for displaying image content is small, the display area for displaying the process screen by the word-processing application, as well as the display area for displaying image content, is displayed on the LCD 17 at the same time. In this case, the user may be viewing the process content by the word-processing application, other than the image content. Thus, the personal computer 10 restores the brightness of the backlight 17a to the original brightness level, thereby preventing the process content by the word-processing application from becoming difficult to view.

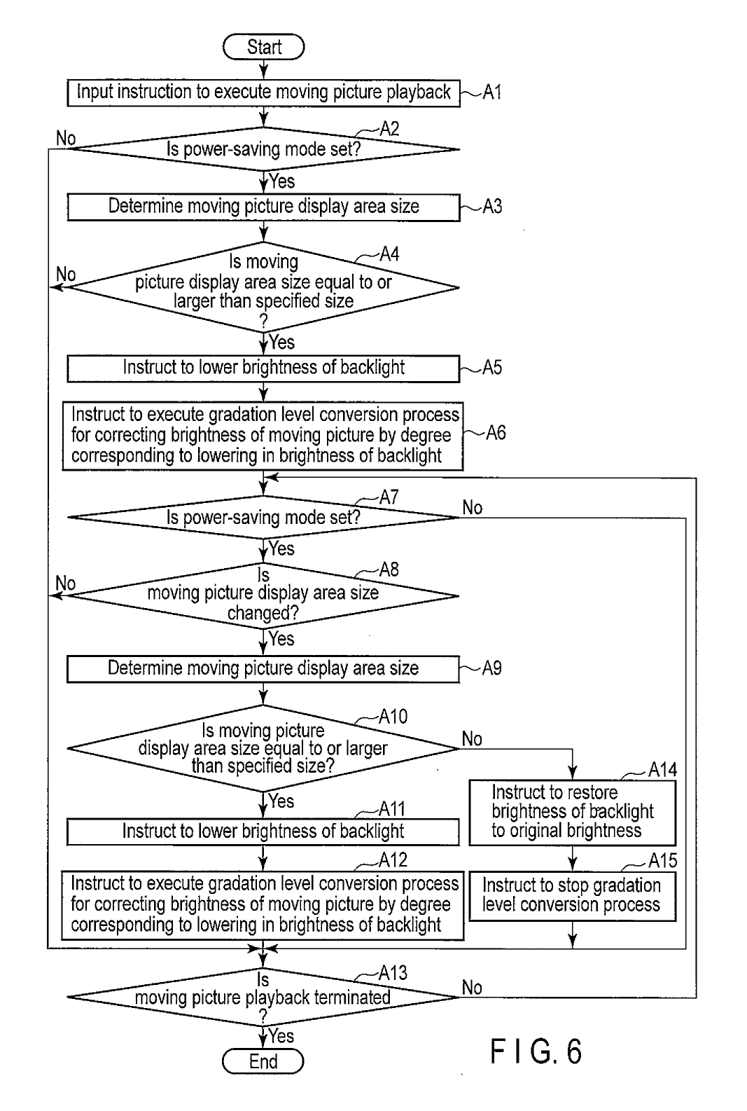

FIG. 6 is an exemplary flow chart illustrating an operation in the embodiment.

In this embodiment, the image display application program 202 executes control of the brightness level of the backlight 17a in accordance with the size of the display area for display image content, and control of the gradation level conversion process on the image content for correcting the decrease in brightness of the backlight 17a. The CPU 111 executes the following process according to the image display application program 202. The description is given of, by way of example, the case of playing back moving picture content by the image display application program 202.

The embodiment is not limited to the playback of moving picture content. The embodiment is applicable to applications which display images including a large amount of data at intermediate gradation levels, such as still image content.

If an instruction to execute moving picture playback has been input by the user's input operation (block A1), the CPU 111 determines whether a power-saving mode is set or not, for example, by referring to the power-saving mode data 121a recorded in the HDD 121. If the power-saving mode is not set, the CPU 111 executes moving picture playback by the image playback module 202a of the image display application program 202. The image playback module 202a displays, by the control of the OS 200, a moving picture in a display area (window) which is provided in the screen of the LCD 17.

The display area for displaying moving picture content is determined by, for example, either a full-screen mode which sets the display area on the whole screen, or a window mode which sets the display area in a part of the screen. For example, it is assumed that whether the display size at the time of activation is in the full-screen mode or in the window mode is set in the image display application program 202. In the window mode, the display area can be set with a predetermined size, or the display area at the time of the end of the previous operation can be set. Under the control of the OS 200, the display area can be altered to an arbitrary position or size by the user operation.

When the power-saving mode is not set (No in block A2), the CPU 111 displays the moving picture content in the display area in the normal operation state, without lowering the brightness of the backlight 17a. Until the end of playback of the moving picture content (No in block A13), the CPU 111 continues the moving picture playback by the image playback module 202a (No in block A2).

On the other hand, if the power-saving mode has been set (Yes in block A2), the CPU 111 determines whether the size of the display area for displaying the moving picture content is a preset specified size or more, by the process of the display area determination module 202b (block A3). For example, when the full-screen mode is set at the time of activation of the image display application program 202, the display area determination module 202b can determine that the size of the display area is the specified size or more. When the window mode is set, the display area determination module 202b acquires, from the OS 200, data such as the size of the LCD 17, the size and display position of the display area for displaying the moving picture content by the image display application program 202, and executes the determination, based on this data.

It is assumed that the specified size is set to be such a size that the display area for displaying the image by the image display application program 202 occupies the most part of the display screen of the LCD 17 and that little process content by some other application, etc. is displayed. For example, in the case where the size of the moving picture display area for displaying the moving picture content is the specified size or more, this case corresponds to the state in which the display area for displaying the process content by the other application is hidden by the moving picture display area. In this case, it can be determined that the user intends to view only the moving picture content, and is not viewing the process content of the other application. In addition, when the size of the moving picture display area for displaying the moving picture content is smaller than the specified size, it can be determined that the user may be viewing the process content of the other application, as well as the moving picture content.

When it is determined that the size of the moving picture display area is smaller than the specified size (No in block A4), the CPU 111 displays the moving picture content in the display area in the normal operation state, without lowering the brightness of the backlight 17a.

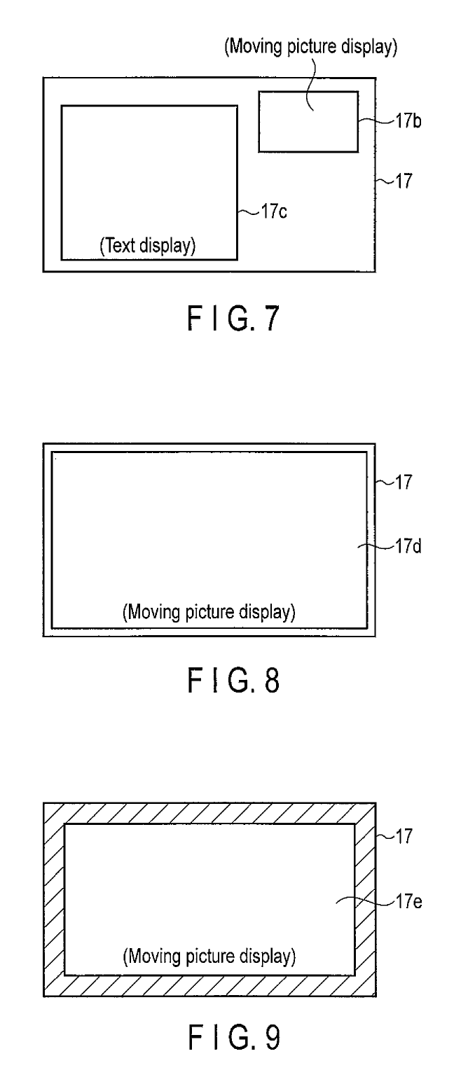

FIG. 7 shows an example of the display screen of the LCD 17. In FIG. 7, a moving picture display area 17b is set for displaying moving picture content by the image display application program 202. In addition, a display area 17c is set for displaying text which is created by, for example, a word-processing application.

In this case, since the moving picture display area 17b is determined to be smaller than the specified size, the brightness of the moving picture display area 17b is not lowered. Accordingly, it is possible to prevent the text displayed in the display area 17c from becoming difficult to view.

On the other hand, when it is determined that the size of the moving picture display area is the specified size or more (Yes in block A4), the CPU 111 lowers, by the backlight brightness adjusting module 202c, the brightness of the backlight 17a in order to effect power-saving. The backlight brightness adjusting module 202c instructs the OS 200 to lower the brightness of the backlight 17a (block A5). In accordance with the instruction from the backlight brightness adjusting module 202c, the OS 200 lowers, by the backlight controller 114a, the brightness of the backlight 17a to a predetermined brightness (e.g. ½ of the brightness at the normal operation time). Thereby, the power consumption by the backlight 17a is reduced.

In addition, the image gradation level conversion module 202d instructs the OS 200 to execute the gradation level conversion process for correcting the surface brightness at the time when the moving picture content is displayed on the LCD 17, by the degree corresponding to the decrease in brightness of the backlight 17a by the control of the backlight brightness adjusting module 202c (block A6).

The OS 200 instructs, via the display driver 201, the GPU 116 to execute the gradation level conversion process for the moving picture content in order to correct the decrease of the brightness of the backlight 17a. The GPU 116 executes, by the gradation level conversion module 116a, predetermined gradation level conversion for image data of the moving picture content, and displays the moving picture content in the moving picture display area.

FIG. 8 and FIG. 9 show examples of the display screen of the LCD 17. FIG. 8 shows a display example in the case where the moving picture content is displayed in the full-screen mode. The moving picture display area 17d is set on the whole screen of the LCD 17. FIG. 9 shows a display example in the case where the moving picture content is displayed in the window mode. A moving picture display area 17e is set on the most part of the display screen of the LCD 17. The size of the moving picture display area 17e is the specified size or more, and an image, which is different from the moving picture content that is displayed by the image display application program 202, is displayed at the periphery of the moving picture display area 17e.

As shown in FIG. 8 and FIG. 9, on the display screen of the LCD 17, the moving picture display areas 17d and 17e, which are intended for the viewing of only the moving picture content, are set.

The gradation level conversion process for the moving picture content is executed, for example, according to the following equations (1) and (2):

y=a×x (x<th1) (1)

y=b×(x−th1)+a×th1 (th1<=x) (2)

y: gradation level after gradation level conversion, x: input gradation level, a: positive number, b: positive number, th1: threshold.

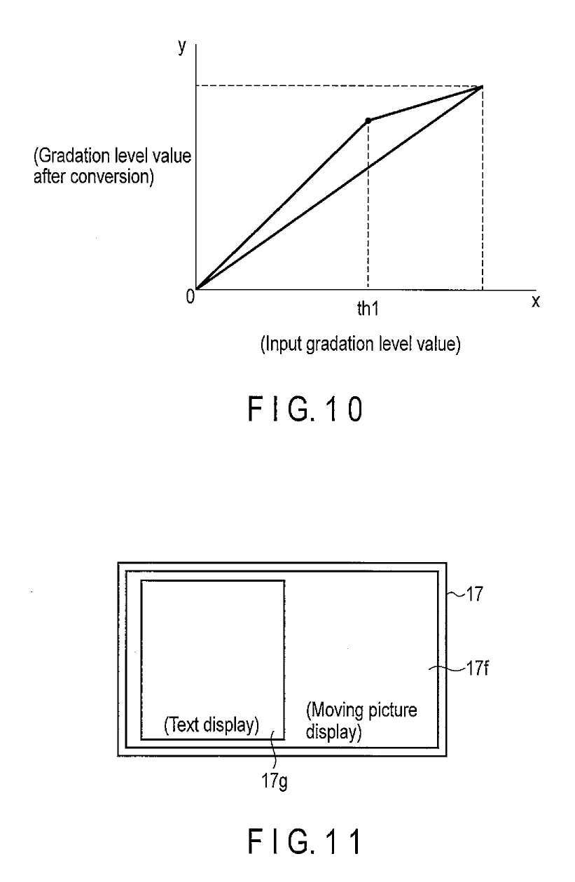

FIG. 10 is a graph illustrating the gradation level conversion, which is expressed by the equations (1) and (2). As shown in FIG. 10, a gradation level value (input gradation level x) of moving picture content is multiplied by the coefficient a for correcting the decrease in brightness of the backlight 17a, thereby calculating a gradation level value after gradation level conversion. For example, when the brightness value of the backlight 17a is decreased to ½, the gradation level value is doubled (a=2). Thereby, the surface brightness of the LCD 17, which displays moving picture content, is made equal to the surface brightness at a time prior to the decrease of the brightness of the backlight 17a. Actually, based on the capabilities of the backlight 17a and LCD 17, the coefficient a for correcting the variation in brightness of the backlight 17a is determined.

The coefficient a applies to input gradation levels up to the predetermined threshold Th1. A coefficient b, which is different from the coefficient a, is set for an input gradation level x which is higher than the threshold Th1 (a>b). For example, as shown in FIG. 10, the coefficient b is set so that at the gradation level value 255 which represents white, the gradation level value of the input gradation level x may become equal to the gradation level value of the gradation level y after the gradation level conversion.

When the gradation level value of the input gradation level x is high, even if the gradation level y after the gradation level conversion is calculated by multiplying the input gradation level x by the coefficient a, the display surface brightness corresponding to the decrease in brightness of the backlight 17a cannot be corrected (see FIG. 5). In the present embodiment, the threshold th1 is set for the gradation level value which can be corrected by the coefficient a. As regards the input gradation level x which is higher than the threshold th1, the gradation level conversion is executed by using the coefficient b which is different from the coefficient a.

In the above-described gradation level conversion process, one threshold th1 is set for the input gradation level x. Alternatively, the gradation level conversion may be executed on the input gradation level x by setting, for example, a plurality of thresholds th1, th2, th3, . . . , and setting different coefficients for the respective thresholds. Thereby, the correction for the decrease in brightness of the backlight 17a can be precisely executed.

In the above description, the brightness of the backlight 17a is decreased to ½. Alternatively, a plurality of levels, to which the brightness of the backlight 17a is decreased, may be set by the power-saving utility program 203. For example, the brightness of the backlight 17a may be decreased to any one of ⅔, ½ and ⅓. In this case, coefficients, which are used in the above-described equations (1) and (2), are prepared in association with ⅔, ½ and ⅓ to which the brightness of the backlight 17a is decreased. In the gradation level conversion process, gradation level conversion is executed based on the above-described equations (1) and (2), by selecting a coefficient value in accordance with a brightness level to which the brightness of the backlight 17a has been decreased.

In the meantime, when an instruction to change the size of the moving picture display area has been input while the moving picture is being played back by the image playback module 202a (Yes in block S8), the CPU 111 determines whether the size of the display area for displaying the moving picture content is the preset specified size or more, by the process of the display area determination module 202b (block A9).

When it is determined that the size of the moving picture display area is smaller than the specified size (No in block A10), the CPU 111 causes the backlight brightness adjusting module 202c to instruct the OS 200 to restore the brightness of the backlight 17a to the original brightness level (the brightness level at the normal operation time) (block A14). In accordance with the instruction from the backlight brightness adjusting module 202c, the OS 200 restores, by the backlight controller 114a, the brightness of the backlight 17a to the original brightness level. In addition, the image gradation level conversion level 202d instructs the OS 200 to stop the gradation level conversion process (block A15). Thereby, the screen of the LCD 17 is displayed, like the case of the normal operation time.

Specifically, when the size of the moving picture display area has been changed to a size smaller than the specified size while the moving picture is being played back and displayed, it is possible that the user intends to confirm, for example, the process content of the word-processing application. As described with reference to FIG. 5, in the display area which displays the process content of the word-processing application, when the brightness of the backlight 17a has been lowered, the process content becomes difficult to view, even if the black-and-white screen is subjected to the gradation level conversion process. Thus, when the size of the moving picture display area has been changed to a size smaller than the specified size, the brightness of the backlight 17a is restored to the original brightness level, thereby preventing the display content other than the moving picture, which is displayed on the LCD 17, from becoming difficult to view.

In the meantime, when the size of the moving picture display area has been changed to a size which is the specified size or more while the moving picture is being played back (blocks A8 to A10), the CPU 111 lowers, by the backlight brightness adjusting module 202c, the brightness of the backlight 17a in order to effect power-saving. The backlight brightness adjusting module 202c instructs the OS 200 to lower the brightness of the backlight 17a (block All). In accordance with the instruction from the backlight brightness adjusting module 202c, the OS 200 lowers the brightness of the backlight 17a to a predetermined brightness by the backlight controller 114a. Thereby, the power consumption by the backlight 17a can be reduced.

In addition, the image gradation level conversion module 202d instructs the OS 200 to execute the gradation level conversion process for correcting the surface brightness at the time when the moving picture content is displayed on the LCD 17, by the degree corresponding to the decrease in brightness of the backlight 17a by the control of the backlight brightness adjusting module 202c (block A12).

The OS 200 instructs, via the display driver 201, the GPU 116 to execute the gradation level conversion process for the moving picture content in order to correct the decrease of the brightness of the backlight 17a. The GPU 116 executes, by the gradation level conversion module 116a, predetermined gradation level conversion of image data of the moving picture content, and displays the moving picture content in the moving picture display area.

Even in the case where the power-saving mode was not set when the image display application program 202 was activated, when the power-saving mode has been set by the power-saving utility program 203 while the moving picture is being played back (Yes in block A7), the brightness of the backlight 17a can be lowered and the power saving can be effected, as described above, if the size of the moving picture display area is the specified size or more.

In the above description, for example, when the size of the moving picture display area 17d of the full-screen mode has become smaller than the specified size in the state in which the brightness of the backlight 17a is lowered, the brightness of the backlight 17a is restored to the original brightness. Alternatively, when the image display application 202 has been rendered inactive, the brightness of the backlight 17a may be restored to the original brightness. For example, as shown in FIG. 11, in the case where a moving picture is displayed in a moving picture display area 17f of the full-screen mode, when the word-processing application has been activated (the image display application program 202 is rendered inactive), the brightness of the backlight 17a may be restored to the original brightness.

As has been described above, in the personal computer 10 of this embodiment, when the moving picture is displayed in the moving image display area with the specified size or more, for example, the size of the full-screen mode or more, the brightness of the backlight 17a is lowered and the moving picture content is subjected to the gradation level conversion process for correcting the lowered brightness. Thereby, the power consumption can be reduced while the decrease in display brightness is suppressed, and the moving picture playback can be executed at low power consumption, without making the user aware of the decrease in brightness.

The specified size has been described above as being preset in the image display application program 202. Alternatively, the user may arbitrarily set the specified size. For example, the image display application program 202 is provided with a size setting function for setting the specified size in accordance with an instruction from the user. If the setting of the specified size has been requested by the user, the image display application program 202 causes the LCD 17 to display a screen for setting the specified size. The screen for setting the specified size enables, for example, designation of the ratio of the display area for displaying an image by the image display application program 202 to the whole screen of the LCD 17, or enables selection of the ratio from a plurality of choices (e.g. 95%, 90%, 85%). The image display application program 202 accepts an instruction from the user through the screen for setting the specified size, and records the data indicative of the specified size in, e.g. the HDD 121. When the size of the display area has been changed, the display area determination module 202b refers to the data indicative of the specified size, which is recorded in the HDD 121, and determines whether the size of the display area is the specified size or more.

In addition, in the above description, when the power-saving mode is set by the power-saving utility program 203, the gradation level conversion process is executed. However, the gradation level conversion process may be executed, regardless of the setting of the power-saving mode. For example, even in the case where the power-saving mode is not set, if the moving picture is displayed with a display size which is a predetermined size or more, for example, with a size of a full-screen mode, the power saving is effected by executing the gradation level conversion process which lowers the brightness of the backlight 17a and increases the gradation level value of the image content.

In the above description, the power-saving mode is set by the power-saving utility program 203. However, for example, a power-saving mode for the time of moving picture (still image) display may be set by the image display application program 202. Regardless of the setting by the power-saving utility program 203, the image display application program 202 executes the above-described process when the power-saving mode for the time of moving picture (still image) display is set.

In the above description, the image display application program 202 is caused to execute the process of the flow chart illustrated in FIG. 6. Alternatively, for example, the process of FIG. 6 may be executed by a power-saving utility program which is different from the image display application program 202. In this case, when an application for displaying an tone image, such as the image display application program 202, is being executed, the power-saving utility program inputs, from the OS 200, the data indicative of the position, size, etc. of the display area corresponding to the application. When it has been determined that the display area of the application in the active state is the specified size or more, the power-saving utility program lowers, via the OS 200, the brightness of the backlight 17a, and executes the gradation level conversion process for the moving picture content, as described above.

In this case, a plurality of applications, which are targets of processing, may be registered in advance in the power-saving utility program. Thereby, even in the case where a moving picture or the like is displayed by an existing image display application program, the power consumption can be reduced in the same manner as described above.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display;
a backlight configured to turn on with a first brightness or a second brightness which has a lower brightness level than the first brightness;
a backlight adjusting module configured to adjust a brightness of the backlight to the second brightness in response to changing of a size of a display area for displaying content on the display to a specified size or more when the backlight is turned on with the first brightness; and
a gradation level converter configured to execute gradation level conversion to increase a gradation level value of the content in response to lowering of a brightness of the backlight to the second brightness.

2. The electronic apparatus of claim 1, wherein in response to changing of the size of the display area to a size smaller than the specified size, the backlight adjusting module is configured to restore the brightness of the backlight to the first brightness, and the gradation level converter is configured not to execute the gradation level conversion of the content.

3. The electronic apparatus of claim 1, further comprising a setting module configured to set a power-saving mode,
wherein the backlight adjusting module is configured to turn on the backlight with the second brightness when the power-saving mode is set.

4. The electronic apparatus of claim 1, wherein the backlight adjusting module is configured to turn on the backlight with the second brightness in response to changing of the size of the display area to a full-screen size of the display.

5. The electronic apparatus of claim 1, further comprising a size setting module configured to set the specified size in accordance with an instruction from a user.

6. The electronic apparatus of claim 1, wherein the content comprises an image.

7. The electronic apparatus of claim 1, wherein the backlight adjusting module is configured to turn on the backlight with the second brightness, when the size of the display area is the specified size or more and the display area is active.

8. A display control method comprising:
adjusting a brightness of a backlight to a second brightness having a lower brightness level than a first brightness in response to changing a size of a display area for displaying content on a display to a specified size or more when the backlight is turned on with the first brightness; and
executing gradation level conversion to increase a gradation level value of the content in response to lowering of a brightness of the backlight to the second brightness.
